(19) United States
(12) Patent Application Publication
(10) Pub. No.: US 2009/0245923 A1
(43) Pub. Date: Oct. 1, 2009

(54) Inner-page structure of a document file

(76) Inventor: Shang-Chiai Kung, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,964

(22) Filed: Mar. 26, 2008

(51) Int. Cl. B42F 13/00; B65D 85/30

(52) U.S. Cl. 402/79; 206/308.1

(57) ABSTRACT

This invention relates to an inner-page structure of a document file, mainly comprising a plurality of inner pages which may be document bags or bags for receiving optical disks etc. A projecting rib is provided at one side of the inner pages with respect to a retaining seat of the document file. The projecting rib has an engaging portion provided on the outer end for engagement with a groove of the retaining seat when the projecting rib is fittingly inserted into the groove of the retaining seat. In this manner, the inner page can be directly fixed with the retaining seat so as to enhance the entire operation performance.

### BACKGROUND OF THE INVENTION

1. Field of the Invention

The present invention relates to an inner-page structure of a document file, particularly to an inner-page structure of the document file in which the inner pages are directly fixed with the retaining seat so as to enhance the entire operation performance.

2. Brief Description of the Prior Art

Generally, people use various document files to accommodate a variety of documents or data media. The document file in early stage is formed by a front cover and a back cover connected together at adjacent side edge, and the documents or data media are clipped directly between the front cover and the back cover of the document file. However, the documents or data media are easily to slide out or to fall down from the document file by using this type of document file. Therefore, a document file is provided to have a connecting piece connected between the front cover and the back cover and a clipping structure provided on the connecting piece so that various documents or data media can be fixed by the clipping structure. However, it is found that the documents and data media are clipped together by the clipping structure. If parts of the documents or data media would like to be extracted out, the clipping structure should be completely opened so as to select the required part of the documents or data media. This will cause great inconvenience in practical use.

In view of the above defect, the inventor developed a document file in which a retaining seat is provided on the inside end face of the connecting piece of the document file, several longitudinal grooves being provided in the retaining seat, partitioning plates being provided between the grooves for partitioning the grooves, inlet ports being formed at both ends of each groove, a stopping plate vertical to the partitioning plates being formed on the top edge of each groove, a document fixer of long strip body shape being formed corresponding to each groove, a cylindrical projecting rib formed on the fixer at a side facing the retaining seat being inserted into the groove from the inlet port at one end of the groove, the documents or the data media being fixed at the other end of the document fixer. When a part of documents is needed, the required documents can be extracted together with the document fixer from the groove of the retaining seat of the document file. In this manner, acquisition of the required documents is very convenient and the integrity of the document file can be maintained.

While the abovementioned document file can achieve the expected effectiveness of acquiring the required documents or data media conveniently from the document file, it is found in practice that objects such as documents or data media etc. to be received within the document bags or bags for receiving optical disks have to be fixed by the document fixer. This will cause troublesome and inconvenience in usage.

In view of the above defect encountered, the inventor of the present invention thus undergoes the research and improvement with respect to the defect and structure of prior art with a mind and spirit in pursuit of excellence based on the professional knowledge and experience accumulated in the long term involvement of relevant field, and eventually proposes a novel inner-page structure of document file so as to obtain the object of achieving better value in practical use.

### SUMMARY OF THE INVENTION

The inner-page structure a document file of the present invention mainly comprises a plurality of inner pages with respect to the document file, the inner pages may be document bags or bags for receiving optical disks etc. Projecting ribs are provided at one side of the inner pages with respect to the retaining seat of the document file. The projecting rib has an engaging portion provided on the outer end for engagement with the groove of the retaining seat when the projecting rib is fittingly inserted into the groove of the retaining seat. In this manner, the inner pages can be directly fixed with the retaining seat so as to enhance the entire operation performance.

### BRIEF DESCRIPTION OF THE DRAWINGS

The present invention will be better understood by the detailed description of the following preferred embodiment with reference to the accompanying drawings, in which:

FIG. 1 is a perspective exploded structural view of the present invention.

FIG. 2 is a perspective exploded structural view of another embodiment of the present invention.

FIG. 3 is a partially enlarged perspective structural view of the present invention fixed on the paper of the present invention.

FIG. 4 is a sectional view, seen from an end, of the present invention in using status.

### DETAILED DESCRIPTION OF THE PREFERRED EMBODIMENT

The technical contents of the present invention will become more apparent from the detailed description of the preferred embodiment in conjunction with the accompanying drawings.

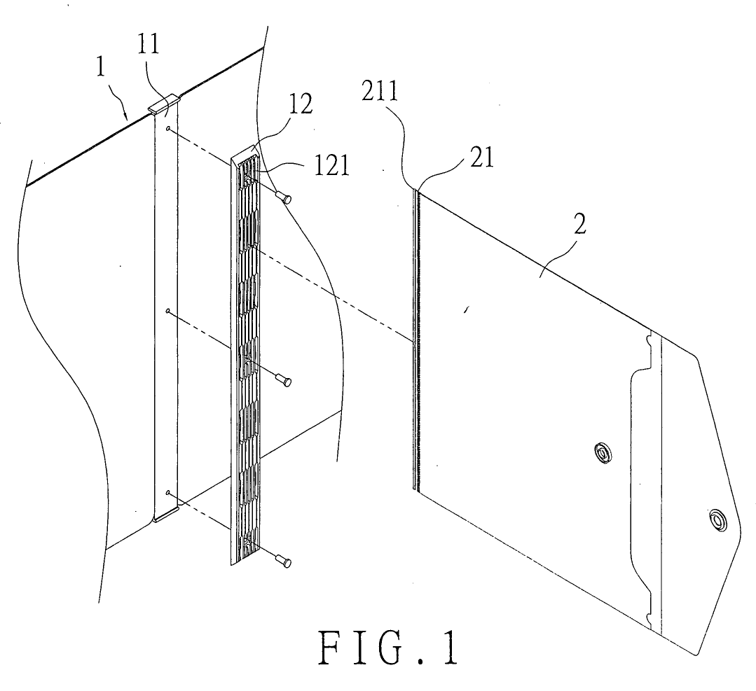

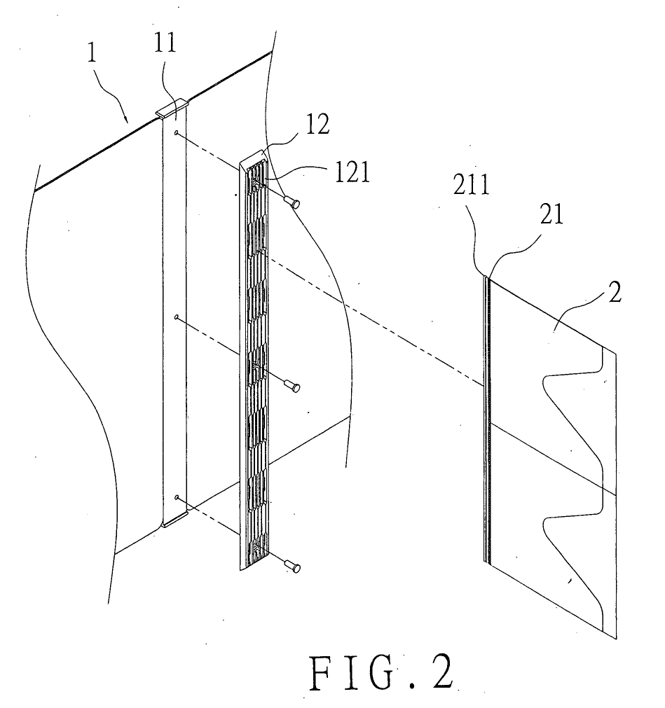

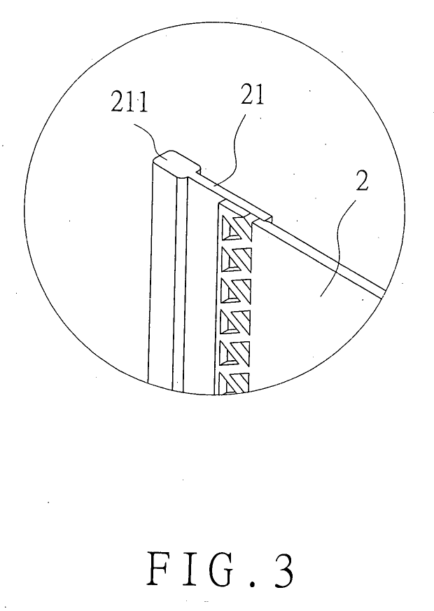

Firstly referring to FIGS. 1, 2 and 3, respectively a perspective exploded structural view of the present invention, a perspective exploded structural view of another embodiment of the present invention, and a partially enlarged perspective structural view of the present invention fixed on the paper of the present invention, the present invention is mainly formed by the collocation of a document file (1) and inner pages (2), in which:

said document file (1) is provided with a retaining seat (12) on the inside end face of the connecting piece (11), several longitudinal grooves (121) being provided in the retaining seat (12), said inner pages (2) being document bags or optical disk receiving bags etc., a projecting rib (21) corresponding to a groove (121) of the retaining seat (12) being provided at one side facing the retaining seat (12) of the document file (1), an engaging portion (211) being provided at the outer end of each projecting rib (21).

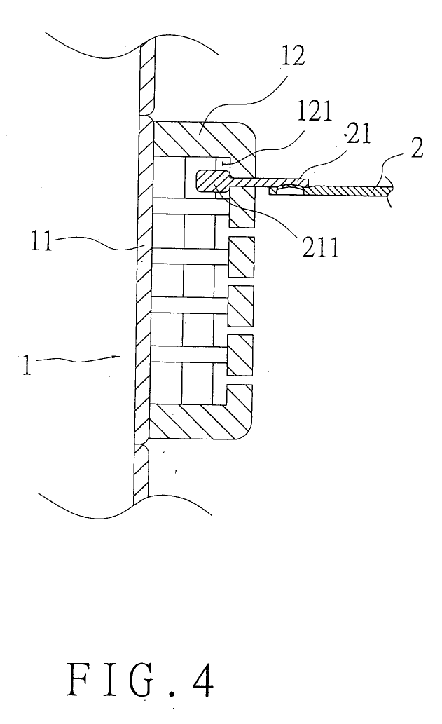

Furthermore, referring to FIG. 4 showing a sectional view, seen from an end, of the present invention in using status, the projecting rib (21) of an inner page (2) is inserted into the groove (121) from one end of the groove (121) of the retaining seat (12) of the document file (1), and then the engaging portion (211) provided at the outer end of the projecting rib (21) is in engagement with the groove (121) and is fixed therein, so that the inner page (2) can be combined with the document file (1) stably. Accordingly, the inner page (2) can be used to receive various documents or optical disks containing data etc.

While the present invention has been described with preferred embodiment in conjunction with the accompanying drawings, it is noted that the preferred embodiment and the drawings are purely for the convenience of description only, not intended to be restrictive on the structural aspect or size of the present invention. Modifications and variations proposed by the person skilled in the art without departing from the spirit of the present invention are considered to be still within the scope of the present invention.

Based on the foregoing, when comparing with prior art, the present invention comprises a plurality of inner pages with respect to the document file. A projecting rib is provided at one side of the inner pages with respect to the retaining seat of the document file. The projecting rib has an engaging portion provided on the outer end for engagement with the groove of the retaining seat when the projecting rib is fittingly inserted into the groove of the retaining seat. In this manner, the inner pages can be directly fixed with the retaining seat so as to enhance the entire operation performance.

Summing up above, the embodiment of this invention can reach expected effectiveness, and the specific configurations disclosed herein have yet not seen in the prior art of the same category of product, even has not been opened to the public before application.

What is claimed is:

1. An inner-page structure of a document file, mainly formed by the collocation of a document file (1) and inner pages (2), wherein:
said document file (1) is provided with a retaining seat (12)-on the inside end face of a connecting piece (11), several longitudinal grooves (121) being provided in the retaining seat (12), a projecting rib (21) corresponding to a groove (121) of the retaining seat (12) being provided at one side facing the retaining seat (12) of the document file (1), an engaging portion (211) being provided at the outer end of the projecting rib (21).

2. An inner-page structure of a document file as claimed in claim 1, wherein said inner page is a document bag.

3. An inner-page structure of a document file as claimed in claim 1, wherein said inner page is a bag for receiving optical disks.
